(19) United States
(12) Patent Application Publication
(10) Pub. No.: US 2025/0286970 A1
(43) Pub. Date: Sep. 11, 2025

(54) INFORMATION PROCESSING APPARATUS, INFORMATION PROCESSING METHOD, AND NON-TRANSITORY COMPUTER-READABLE STORAGE MEDIUM STORING PROGRAM

(71) Applicant: SEIKO EPSON CORPORATION, TOKYO (JP)

(72) Inventors: Koki NOMURA, AZUMINO-SHI (JP); Ryotaro HAYASHI, SHIOJIRI-SHI (JP)

(21) Appl. No.: 19/070,592

(22) Filed: Mar. 5, 2025

(30) Foreign Application Priority Data
Mar. 5, 2024 (JP) 2024-032764

(51) Int. Cl. H04N 1/00

(52) U.S. Cl. CPC H04N 1/0066; H04N 1/00663

(57) ABSTRACT

An information processing apparatus includes a correspondence information storage portion that stores correspondence information in which a plurality of pieces of type information and a plurality of pieces of pattern information are associated with each other. The information processing apparatus includes the type information acquisition portion that acquires type information of a medium set for the print job that the printing apparatus intends to execute. The information processing apparatus includes the pattern information extraction portion that extracts pattern information corresponding to the type information acquired by the type information acquisition portion from a plurality of pieces of pattern information stored in the pattern information storage portion by referring to the correspondence information. The information processing apparatus includes the display control portion that displays the pattern information extracted by the pattern information extraction portion.

The present application is based on, and claims priority from JP Application Serial Number 2024-032764, filed Mar. 5, 2024, the disclosure of which is hereby incorporated by reference herein in its entirety.

### BACKGROUND

### 1. Technical Field

The present disclosure relates to an information processing apparatus, an information processing method, and a non-transitory computer-readable storage medium storing a program.

### 2. Related Art

JP-A-2022-159645 discloses that, when printing on a first medium using a flatbed printer, a second medium for positioning the first medium is generated and printed in order to dispose the first medium at an appropriate position of a placement table of the flatbed printer. The image printed on the second medium for positioning includes a frame line indicating the contour of the first medium.

In JP-A-2022-159645, when performing printing on the first medium, the first medium is positioned on the placement table using the second medium different from the second medium corresponding to the first medium, and as a result, there is a concern that the first medium may be lost.

### SUMMARY

According to an aspect of the present disclosure, there is an information processing apparatus that controls a printing apparatus executing a print job on a print medium positioned by using a positioning medium on which a positioning pattern is printed, the information processing apparatus including: a type information storage portion that stores a plurality of pieces of type information each indicating a plurality of different types of the print medium; a pattern information storage portion that stores a plurality of pieces of pattern information each indicating a plurality of the positioning patterns different from each other; a correspondence information storage portion that stores correspondence information for associating the plurality of pieces of type information and the plurality of pieces of pattern information with each other; a type information acquisition portion that acquires type information of the print medium set for the print job that the printing apparatus intends to execute; a pattern information extraction portion that extracts, from the plurality of pieces of pattern information, pattern information corresponding to the type information acquired by the type information acquisition portion by referring to the correspondence information; and a pattern information display portion that displays the pattern information extracted by the pattern information extraction portion.

According to another aspect of the present disclosure, there is provided an information processing method for controlling a printing apparatus executing a print job on a print medium positioned by using a positioning medium on which a positioning pattern is printed, in which a computer stores a plurality of pieces of type information each indicating a plurality of different types of the print medium, stores a plurality of pieces of pattern information each indicating a plurality of the positioning patterns different from each other, stores correspondence information for associating the plurality of pieces of type information and the plurality of pieces of pattern information with each other, acquires type information of the print medium set for the print job that the printing apparatus intends to execute, extracts, from the plurality of pieces of pattern information, pattern information corresponding to the acquired type information by referring to the correspondence information, and displays the extracted pattern information.

According to still another aspect of the present disclosure, there is provided a non-transitory computer-readable storage medium storing a program that causes a computer that controls a printing apparatus executing a print job on a print medium positioned by using a positioning medium on which a positioning pattern is printed, to function as a type information storage portion that stores a plurality of pieces of type information each indicating a plurality of different types of the print medium, a pattern information storage portion that stores a plurality of pieces of pattern information each indicating a plurality of the positioning patterns different from each other, a correspondence information storage portion that stores correspondence information for associating the plurality of pieces of type information and the plurality of pieces of pattern information with each other, a type information acquisition portion that acquires type information of the print medium set for the print job that the printing apparatus intends to execute, a pattern information extraction portion that extracts, from the plurality of pieces of pattern information, pattern information corresponding to the type information acquired by the type information acquisition portion by referring to the correspondence information, and a pattern information display portion that displays the pattern information extracted by the pattern information extraction portion.

### BRIEF DESCRIPTION OF THE DRAWINGS

FIG. 1 is a block diagram of a printing system.

FIG. 2 is a data structure diagram of correspondence information.

FIG. 3 is a diagram illustrating a GUI of RIP software.

FIG. 4 is a diagram illustrating an example of a medium image.

FIG. 5 is a diagram illustrating an example of a positioning pattern.

FIG. 6 is a diagram illustrating an example of a positioning pattern.

FIG. 7 is a diagram illustrating an example of a positioning pattern.

FIG. 8 is a diagram illustrating an example of a positioning pattern.

FIG. 9 is a control flow when the GUI is displayed.

FIG. 10 is a control flow when a medium image input button is clicked.

FIG. 11 is a control flow when a medium image print button is clicked.

FIG. 12 is a control flow when a positioning pattern print button is clicked.

FIG. 13 is a control flow when a registration button is clicked.

FIG. 14 is a diagram illustrating a display example of a dialog box.

FIG. 15 is a diagram illustrating a display example of a dialog box.

FIG. 16 is a diagram illustrating a display example of a dialog box.

### DESCRIPTION OF EMBODIMENTS

Hereinafter, the present disclosure will be described through embodiments of the present disclosure, but the present disclosure is not limited to the following embodiments. In addition, not all of the configurations described in the embodiment are essential as means that solves the problem. For clarification of the description, the following description and drawings are appropriately omitted and simplified. In each drawing, the same elements will be given the same reference numerals, and the redundant description thereof will be omitted as necessary.

### Summary of Printing System 1

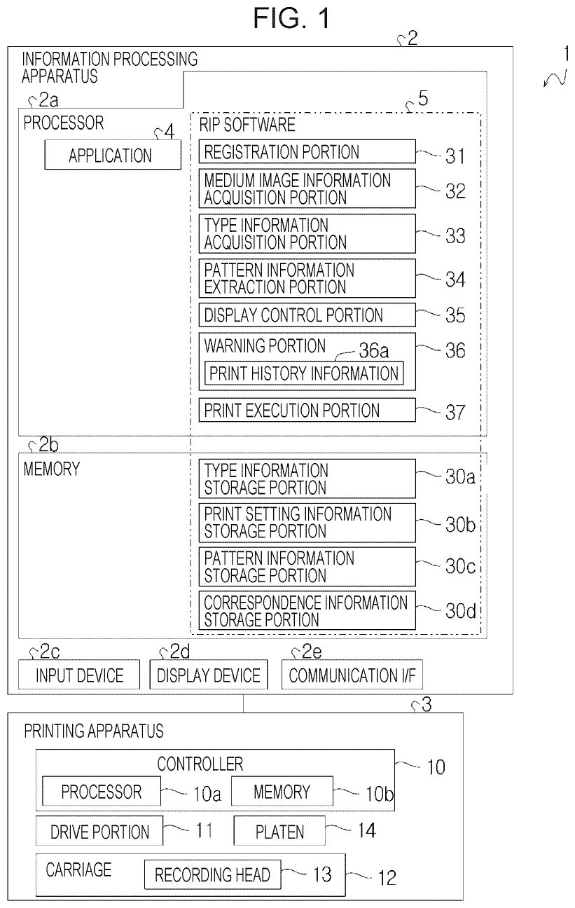

FIG. 1 is a block diagram of a printing system 1. As illustrated in FIG. 1, the printing system 1 includes an information processing apparatus 2 and a printing apparatus 3. The information processing apparatus 2 is typically a personal computer. The printing apparatus 3 is a flatbed printer.

The information processing apparatus 2 includes a processor 2a, a memory 2b, an input device 2c, a display device 2d, and a communication interface 2e. The information processing apparatus 2 communicates with the printing apparatus 3 via the communication interface 2e. The processor 2a can access the memory 2b. The processor 2a reads and executes a program stored in the memory 2b. As a result, the program causes hardware such as the processor 2a to execute the functions of an application 4 and a raster image processor (RIP) software 5.

The input device 2c is a unit for receiving an operation by a user. The input device 2c is typically realized by a keyboard or a pointing device.

The display device 2d is a unit for displaying visual information. The display device 2d is typically realized by a liquid crystal display (LCD) or an organic light emitting diode (OLED).

The application 4 generates medium image data indicating a medium image to be printed on a medium in accordance with a drawing instruction from the user. The application 4 outputs the medium image data to the RIP software 5 in accordance with a print instruction from the user.

The medium is a specific example of a print medium. The medium has a certain thickness, and is typically a smartphone case, a badge, or a key holder, but is not limited to these types. These media are sometimes called commercial products or media, and for example, there are a huge number of types, even just for smartphone cases. In addition, the material may be different when the type of the medium is different, and accordingly, it is necessary to change the print setting parameter when the printing is performed by the printing apparatus 3.

The RIP software 5 generates first print control data based on the medium image data, and transmits the generated first print control data to the printing apparatus 3. The first print control data is data for the printing apparatus 3 to print a medium image.

In addition, the RIP software 5 generates second print control data based on the pattern information indicating the positioning pattern for disposing the medium at an appropriate position in the printing apparatus 3, and transmits the generated second print control data to the printing apparatus 3. The second print control data is data for the printing apparatus 3 to print the positioning pattern. The RIP software 5 is also referred to as a printer driver. Details of the RIP software 5 will be described later.

The print medium on which the positioning pattern is printed is typically paper. Therefore, the paper on which the positioning pattern is printed is also referred to as a positioning paper below. The positioning paper is a specific example of a positioning medium.

The printing apparatus 3 includes a controller 10, a drive portion 11, a carriage 12, a recording head 13, a platen 14, and an ultraviolet (UV) irradiation portion (not illustrated).

The controller 10 includes a processor 10a and a memory 10b. The processor 10a executes processing according to predetermined firmware stored in the memory 10b.

The platen 14 is typically a flat plate in a horizontal posture. A plurality of media are arranged on the platen 14 when printing is simultaneously performed on the plurality of media. Therefore, it can be said that the platen 14 supports a plurality of media. When simultaneously printing on a plurality of media, typically, a positioning paper is set on the platen 14, and the plurality of media are positioned with respect to the platen 14 by using a positioning pattern printed on the positioning paper. In the present embodiment, the platen 14 is provided with the heater for the purpose of promoting the drying of the ink, and the platen temperature can be adjusted by the heater.

The recording head 13 discharges a liquid such as ink by an ink jet method to perform recording. The recording head 13 includes a plurality of nozzles and discharges ink to a plurality of media or papers arranged on the platen 14. The controller 10 controls the recording head 13 with a predetermined discharge waveform based on the first print control data or the second print control data received from the information processing apparatus 2, and discharges or does not discharge the ink from the plurality of nozzles. As a result, the recording head 13 applies the ink to the medium at a desired ink density. In addition, the ink applied on the medium forms an ink layer, and a plurality of ink layers may be provided.

The carriage 12 and the drive portion 11 relatively move the recording head 13 with respect to the platen 14 and the medium. The carriage 12 is provided with the recording head 13, and reciprocates the recording head 13 in the main scanning direction with respect to the platen 14 and the medium. The speed of this reciprocating movement is referred to as a head speed. The drive portion 11 moves the recording head 13 in the sub-scanning direction intersecting the main scanning direction with respect to the platen 14 and the medium. Further, the drive portion 11 changes the distance between the platen 14 and the nozzles of the recording head 13 in the vertical direction intersecting the main scanning direction and the sub-scanning direction. This distance is also referred to as a platen gap. The controller 10 changes the scanning speed, which is the moving speed of the carriage 12, or the size of the platen gap according to the print setting.

The UV irradiation portion is mounted on, for example, the carriage 12, and moves in the main scanning direction with respect to the platen 14 and the medium, similar to the recording head 13. At this time, the ink on the medium is solidified or cured by irradiating the ink on the medium with ultraviolet rays. The controller 10 varies the UV irradiation intensity or the UV irradiation frequency by the UV irradiation portion according to the print setting.

### Details of RIP Software 5

The processor 2a functions as a registration portion 31, a medium image information acquisition portion 32, a type information acquisition portion 33, a pattern information extraction portion 34, a display control portion 35, a warning portion 36, and a print execution portion 37 by executing the program of the RIP software 5. Further, the memory 2b functions as a type information storage portion 30a, a print setting information storage portion 30b, a pattern information storage portion 30c, and a correspondence information storage portion 30d by storing various information in accordance with the program of the RIP software 5.

The type information storage portion 30a stores a plurality of pieces of type information. Each of the plurality of pieces of type information indicates a plurality of different types of media. Each piece of type information typically includes an identification character string for identifying the corresponding type. The identification character string for identifying the type is also referred to as a type identification character string below.

The print setting information storage portion 30b stores a plurality of pieces of print setting information. Each of the plurality of pieces of print setting information indicates a plurality of different print settings. Each print setting information is typically configured with a plurality of print setting parameters.

The pattern information storage portion 30c stores a plurality of pieces of pattern information. Each of the plurality of pieces of pattern information indicates a plurality of different positioning patterns. Each piece of pattern information may include image information of the corresponding positioning pattern. In this case, each piece of pattern information includes an identification character string for identifying the corresponding positioning pattern, and the image information. Each pattern information may include dimension parameters of the grid lines when the corresponding positioning pattern is a grid line that assists in positioning the corresponding medium. In this case, each pattern information includes an identification character string for identifying the corresponding positioning pattern, and the dimension parameter. The identification character string for identifying the positioning pattern is also referred to as a pattern identification character string below.

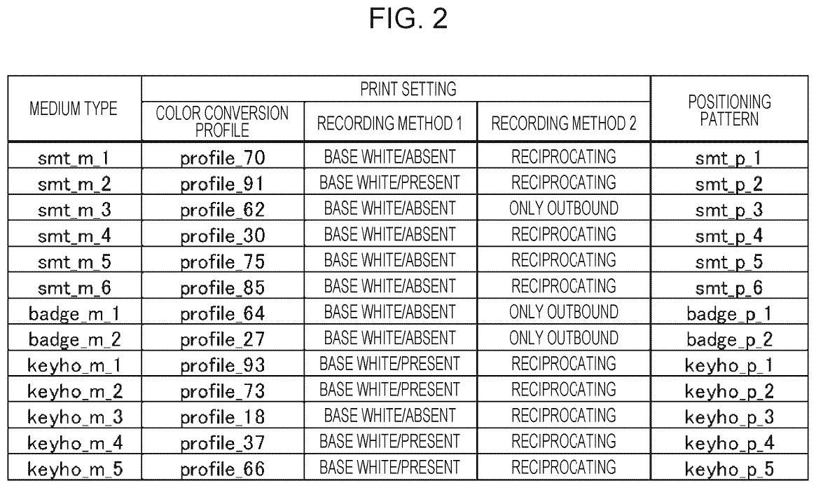

The correspondence information storage portion 30d associates the plurality of pieces of type information, the plurality of pieces of print setting information, and the plurality of pieces of parameter information with each other. FIG. 2 illustrates a data structure diagram of the correspondence information. In FIG. 2, the “medium type” corresponds to the type information. The character strings such as “smt_m_1”, “smt_m_2”, and “keyho_m_1” illustrated in “medium type” are type identification character strings of the corresponding type information. The “print setting” corresponds to the print setting information. The “positioning pattern” corresponds to the pattern information. The character strings such as “smt_p_1”, “smt_p_2”, and “keyho_p_1” illustrated in the “positioning pattern” are pattern identification character strings of the corresponding pattern information.

“smt_m_1” to “smt_m_6” are all type identification character strings related to the smartphone case.

“badge_m_1” and “badge_m_2” are both type identification character strings related to the badge.

“keyho_m_1” to “keyho_m_5” are all type identification character strings related to the key holder.

In the present embodiment, as illustrated in FIG. 2, the correspondence information associates one piece of pattern information with one piece of type information in a one-to-one manner. However, instead of this, a plurality of pieces of pattern information may be associated with one piece of type information in a one-to-many manner.

In the present embodiment, the print setting information storage portion 30b can be omitted. Therefore, the description of the print settings will be omitted below.

The registration portion 31 registers new correspondence relationship in the correspondence information in the correspondence information storage portion 30d. Specifically, the registration portion 31 acquires the type information and the pattern information. The registration portion 31 registers the acquired type information in the type information storage portion 30a and registers the pattern information in the pattern information storage portion 30c. Then, the registration portion 31 registers the correspondence relationship between the type information and the pattern information in the correspondence information storage portion 30d.

The medium image information acquisition portion 32 acquires the medium image data.

The type information acquisition portion 33 acquires type information of the medium set for the print job to be printed by the printing apparatus 3.

The pattern information extraction portion 34 extracts at least one piece of pattern information corresponding to the type information of the medium acquired by the type information acquisition portion 33 from the plurality of pieces of pattern information stored in the pattern information storage portion 30c by referring to the correspondence information of the correspondence information storage portion 30d.

The display control portion 35 is a specific example of a pattern information display portion and a trigger display portion.

The display control portion 35 causes the display device 2d to display the pattern information extracted by the pattern information extraction portion 34 in a character format. Specifically, the display control portion 35 causes the display device 2d to display a pattern identification character string of the pattern information extracted by the pattern information extraction portion 34.

Further, the display control portion 35 causes the display device 2d to display the positioning pattern indicated by the pattern information extracted by the pattern information extraction portion 34 in an image format. Specifically, the display control portion 35 causes the display device 2d to display an image (hereinafter also referred to as a pattern image) of the positioning pattern indicated by the pattern information extracted by the pattern information extraction portion 34. Here, the “image of the positioning pattern” refers to a case where the pattern information includes the image information of the corresponding positioning pattern. In this case, the display control portion 35 displays the image information as a pattern image on the display device 2d. On the other hand, when the pattern information includes the dimension parameter of the corresponding positioning pattern, the display control portion 35 generates a pattern image based on the dimension parameter and displays the generated pattern image on the display device 2d.

Further, the display control portion 35 simultaneously displays the first trigger for starting printing on the medium and the second trigger for starting printing of the pattern image displayed by the display control portion 35, on the display device 2d. Specifically, the following is the case.

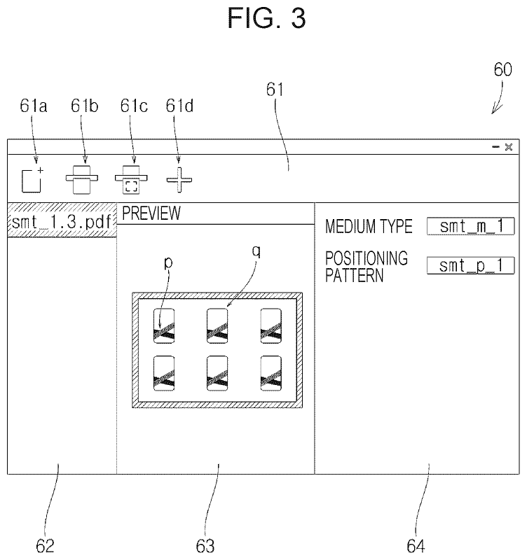

With reference to FIG. 3, a graphical user interface (GUI) 60 of the RIP software 5 to be displayed on the display device 2d by the display control portion 35 will be described. The GUI 60 includes a toolbar 61, a file name list box 62, a preview box 63, and a print job panel 64.

The display control portion 35 displays, in a clickable button format, a medium image input button 61a for inputting medium image data to the toolbar 61, a medium image print button 61b as a first trigger, a positioning pattern print button 61c as a second trigger, and a registration button 61d for registering the type information and the pattern information in association with the correspondence information of the correspondence information storage portion 30d.

The display control portion 35 displays the file name of the medium image data imported by the user to the RIP software 5 in the file name list box 62. In other words, the display control portion 35 displays the file name of the medium image data set for the print job in the file name list box 62.

The display control portion 35 displays a medium image p and a pattern image q indicated by the medium image data in the preview box 63 in a superimposed manner.

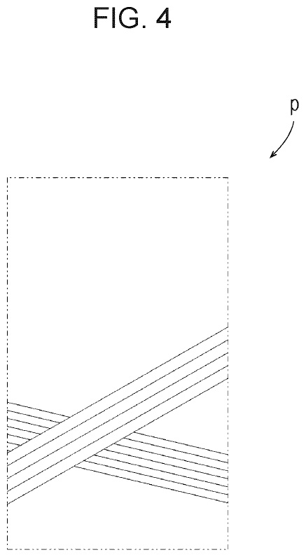

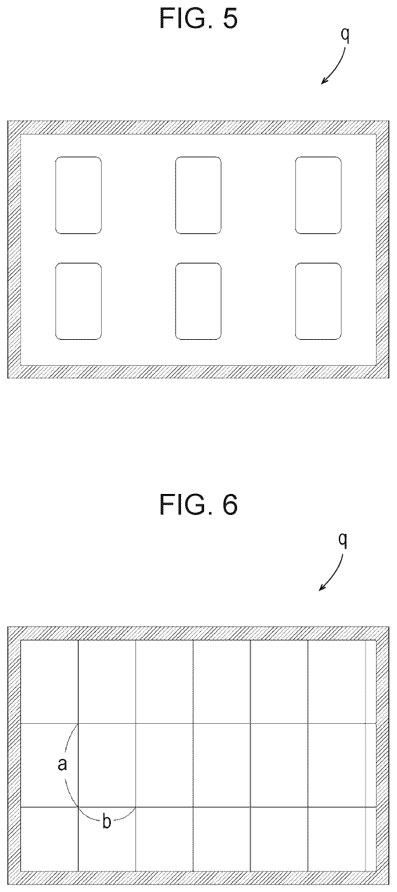

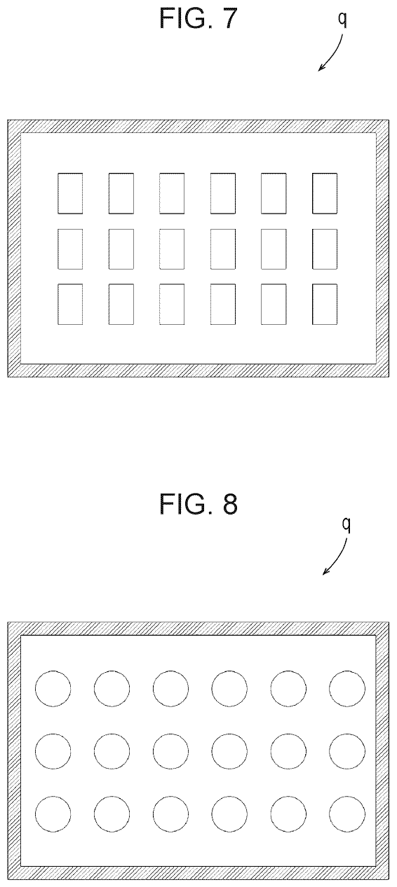

Here, refer to FIGS. 4 to 8. FIG. 4 illustrates an example of the medium image p. In FIG. 4, a two-dot chain line indicates an outer edge of the medium image p. FIGS. 5 to 8 illustrate the pattern image q of the positioning pattern. The positioning pattern illustrated in FIG. 5 is a positioning pattern for a smartphone case and includes an outer contour line of the smartphone case. The positioning pattern illustrated in FIG. 6 is also a positioning pattern for a smartphone case and is configured with grid lines. The positioning pattern illustrated in FIG. 7 is a positioning pattern for a key holder and includes an outer contour line of the key holder. The positioning pattern illustrated in FIG. 8 is a positioning pattern for a badge and includes an outer contour line of the badge.

The display control portion 35 displays the print job setting on the print job panel 64. The print job setting includes at least the type information and the pattern information. That is, the display control portion 35 displays both the type identification character string of the type information acquired by the type information acquisition portion 33 and the pattern identification character string of the pattern information extracted by the pattern information extraction portion 34. In addition, when a plurality of pieces of pattern information correspond to the type information displayed on the print job panel 64, the display control portion 35 may display the pattern identification character string in a pull-down format, and accordingly, the user can change the pattern information of the print job setting. In the example illustrated in FIG. 3, “smt_m_1” is set as the type information and “smt_p_1” is set as the pattern information in the print job.

The warning portion 36 issues a warning to the user by displaying a dialog box. Specifically, the warning portion 36 holds print history information 36a. The print history information 36a indicates the print history of the pattern image corresponding to each pattern information illustrated in FIG. 2. The warning portion 36 refers to the print history information 36a and issues a warning to the user. For example, when the medium image print button 61b is clicked despite the fact that the pattern image corresponding to the pattern information set in the print job was not printed even once during a predetermined past period, or when the positioning pattern print button 61c is clicked despite the fact that the pattern image corresponding to the pattern information set for the print job was printed during the predetermined past period, the warning portion 36 issues a warning to the user. A specific warning aspect by the warning portion 36 will be described later.

The print execution portion 37 executes a print job. Specifically, when the medium image print button 61b is clicked, the print execution portion 37 converts the medium image data set for the print job into the first print control data, and transmits the first print control data to the printing apparatus 3. As a result, the printing apparatus 3 performs printing based on the first print control data. Further, when the positioning pattern print button 61c is clicked, the print execution portion 37 generates the second print control data based on the pattern information set for the print job, and transmits the generated second print control data to the printing apparatus 3. As a result, the printing apparatus 3 performs printing based on the second print control data.

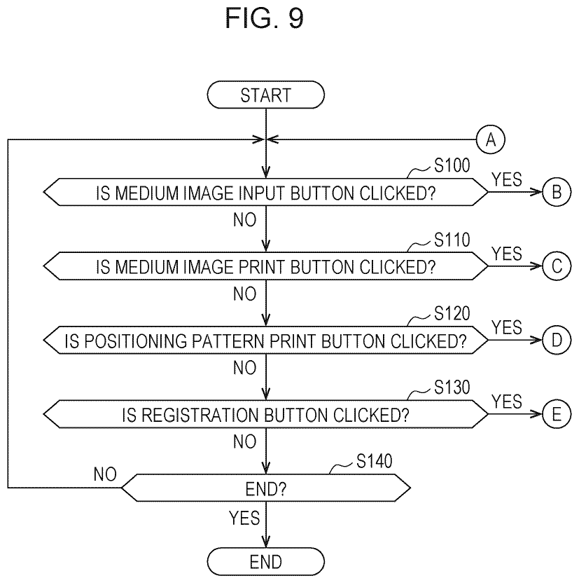

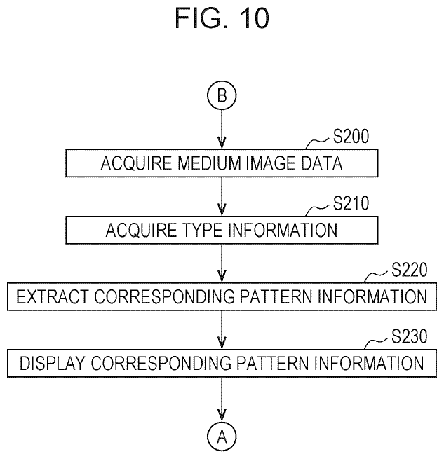

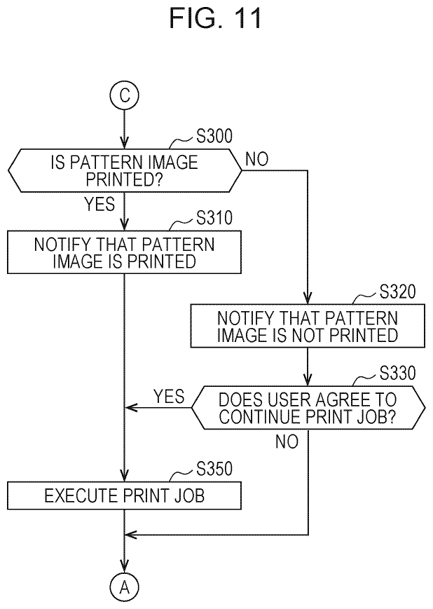

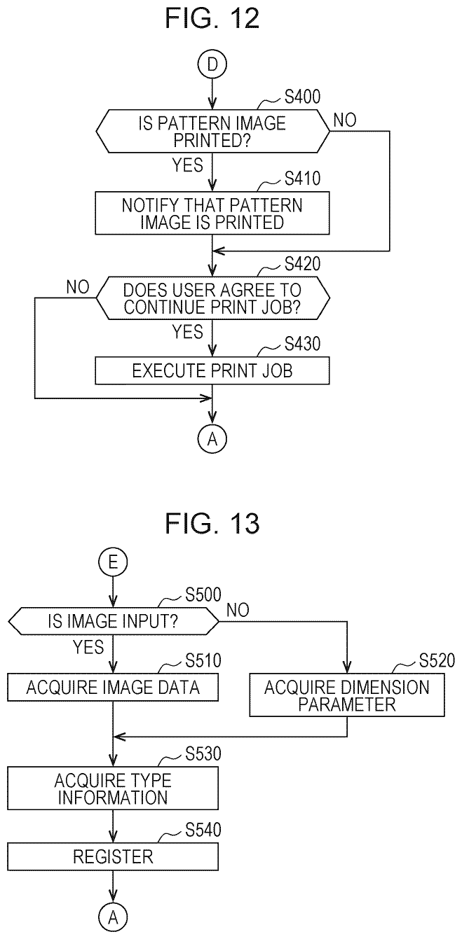

Next, a control flow of the RIP software 5 will be described with reference to FIGS. 9 to 13. FIG. 9 is a control flow when the GUI 60 is displayed. FIG. 10 is a control flow when the medium image input button 61a is clicked. FIG. 11 is a control flow when the medium image print button 61b is clicked. FIG. 12 is a control flow when the positioning pattern print button 61c is clicked. FIG. 13 is a control flow when the registration button 61d is clicked.

As illustrated in FIG. 9, the RIP software 5 determines whether the medium image input button 61a is clicked (S100). When it is determined that the medium image input button 61a is clicked (S100: YES), the RIP software 5 proceeds the process to step S200 in FIG. 10. When it is determined that the medium image input button 61a is not clicked (S100: NO), the RIP software 5 proceeds the process to step S110.

The RIP software 5 determines whether the medium image print button 61b is clicked (S110). When it is determined that the medium image print button 61b is clicked (S110: YES), the RIP software 5 proceeds the process to step S300 in FIG. 11. When it is determined that the medium image print button 61b is not clicked (S110: NO), the RIP software 5 proceeds the process to step S120.

The RIP software 5 determines whether the positioning pattern print button 61c is clicked (S120). When it is determined that the positioning pattern print button 61c is clicked (S120: YES), the RIP software 5 proceeds the process to step S400 in FIG. 12. When it is determined that the positioning pattern print button 61c is not clicked (S120: NO), the RIP software 5 proceeds the process to step S130.

The RIP software 5 determines whether the registration button 61d is clicked (S130). When it is determined that the registration button 61d is clicked (S130: YES), the RIP software 5 proceeds the process to step S500 in FIG. 13. When it is determined that the registration button 61d is not clicked (S130: NO), the RIP software 5 proceeds the process to step S140.

The RIP software 5 determines whether the GUI 60 is closed (S140). When it is determined that the GUI 60 is closed (S140: YES), the RIP software 5 ends the process. When it is not determined that the GUI 60 is closed (S140: NO), the RIP software 5 returns the process to step S100.

### When Medium Image Input Button 61a Is Clicked

As illustrated in FIG. 10, the medium image information acquisition portion 32 of the RIP software 5 displays an open file dialog. As a result, the medium image information acquisition portion 32 acquires the medium image data selected by the user via the open file dialog (S200). The medium image information acquisition portion 32 sets the medium image data selected by the user as the medium image data for the print job.

Next, the type information acquisition portion 33 of the RIP software 5 acquires the type information by analyzing the medium image data selected by the user or based on the input operation of the user (S210). The type information acquisition portion 33 sets the type information acquired by the type information acquisition portion 33 as the type information in the print job.

Next, the pattern information extraction portion 34 of the RIP software 5 extracts the pattern information corresponding to the type information acquired by the type information acquisition portion 33 by referring to the correspondence information (S220), and sets the pattern information as the pattern information for the print job.

Next, the display control portion 35 displays the pattern information extracted by the pattern information extraction portion 34 to the user (S230), and returns the process to step S100 in FIG. 9. Specifically, the display control portion 35 displays the pattern information extracted by the pattern information extraction portion 34 on the GUI 60 in a character format and an image format. As a result, the user can appropriately understand the positioning pattern corresponding to the medium to be printed in the future by checking the display content on the GUI 60, and thus, a mismatch between the medium and the positioning pattern can be prevented.

### When Medium Image Print Button 61b Is Clicked

As illustrated in FIG. 11, the warning portion 36 determines whether the pattern image corresponding to the pattern information set for the print job is printed within the first period from the time when the medium image print button 61b is clicked by referring to the print history information 36a (S300).

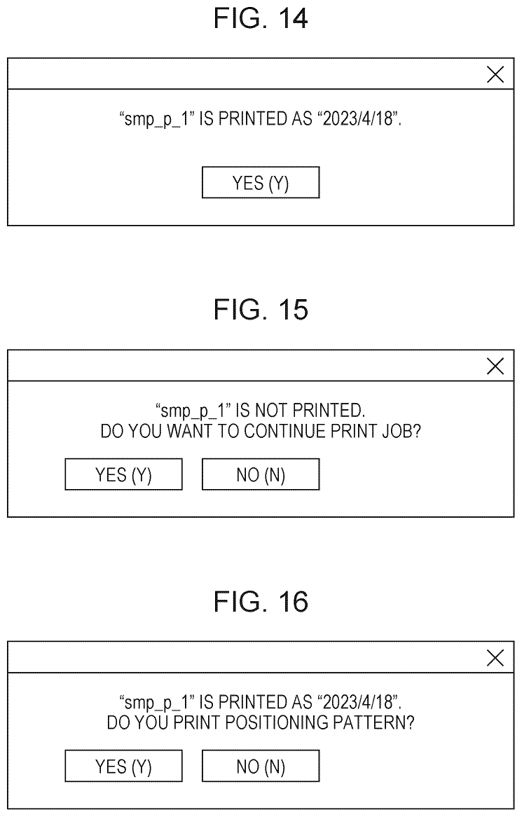

When it is determined that the pattern image corresponding to the pattern information set for the print job is printed within the first period from the time when the medium image print button 61b is clicked (S300: YES), as illustrated in FIG. 14, the warning portion 36 notifies the user that the pattern image corresponding to the pattern information set for the print job is printed by using a dialog box (S310), and proceeds the process to step S350.

When it is determined that the pattern image corresponding to the pattern information set for the print job is not printed within the first period from the time when the medium image print button 61b is clicked (S300: NO), as illustrated in FIG. 15, the warning portion 36 notifies the user that the pattern image corresponding to the pattern information set for the print job is not printed by using a dialog box (S320), and prompts the user to agree to continue the print job (S330). When the user agrees in step S330 (S330: YES), the warning portion 36 proceeds the process to step S350. When the user does not agree in step S330 (S330: NO), the warning portion 36 returns the process to step S100 in FIG. 9.

In step S350, the print execution portion 37 converts the medium image data into the first print control data, transmits the first print control data to the printing apparatus 3 (S350), and returns the process to step S100 in FIG. 9. As a result, the printing apparatus 3 executes printing on the medium according to the first print control data.

The above-described first period is typically set to about one month or three months, but the present disclosure is not limited thereto.

### When Positioning Pattern Print Button 61c Is Clicked

As illustrated in FIG. 12, the warning portion 36 determines whether the pattern image corresponding to the pattern information set for the print job is printed within the second period from the time when the positioning pattern print button 61c is clicked by referring to the print history information 36a (S400).

When it is determined that the pattern image corresponding to the pattern information set for the print job is printed within the second period from the time when the positioning pattern print button 61c is clicked (S400: YES), as illustrated in FIG. 16, the warning portion 36 notifies the user that the pattern image corresponding to the pattern information set for the print job is printed by using a dialog box (S410), and prompts the user to agree to continue printing the positioning pattern set for the print job (S420). When the user agrees in step S420 (S420: YES), the warning portion 36 proceeds the process to step S430. On the other hand, when the user does not agree in step S420 (S420: NO), the warning portion 36 returns the process to step S100 in FIG. 9.

When it is determined that the pattern image corresponding to the pattern information set for the print job is not printed within the second period from the time when the positioning pattern print button 61c is clicked (S400: NO), the warning portion 36 proceeds the process to step S430.

In step S430, the print execution portion 37 converts the pattern image corresponding to the pattern information set for the print job into the second print control data, transmits the second print control data to the printing apparatus 3 (S430), and returns the process to step S100 in FIG. 9. As a result, the printing apparatus 3 executes printing on the paper according to the second print control data.

The above-described second period is typically set to about one month or three months, but the present disclosure is not limited thereto. The second period may have the same time width as the first period, or may be longer or shorter than the first period.

### When Registration Button 61d Is Clicked

As illustrated in FIG. 13, when registering pattern information in the correspondence information, the registration portion 31 asks the user in a dialog box format whether to input the pattern information in an image format (S500). When the user selects to input the pattern information in an image format (S500: YES), the registration portion 31 displays the open file dialog. As a result, the registration portion 31 acquires the image data selected by the user via the open file dialog (S510). On the other hand, when the user does not select to input the positioning pattern in an image format (S500: NO), the registration portion 31 estimates that the pattern information to be registered in the correspondence information by the user is configured with the dimension parameter of the grid line, and displays the input screen for inputting the dimension parameter of the grid line. Here, the “dimension parameter of the grid line” includes at least a vertical distance a and a horizontal distance b of the grid line as illustrated in FIG. 6. As a result, the registration portion 31 acquires the dimension parameter input by the user via the input screen (S520).

Next, the registration portion 31 acquires the type information based on the user input (S530).

Next, the registration portion 31 registers the type information acquired in step S530 in the type information storage portion 30a. The registration portion 31 registers the pattern information acquired in step S510 or step S520 in the pattern information storage portion 30c. The registration portion 31 registers the type information acquired in step S530 and the pattern information acquired in step S510 or step S520 in association with each other in the correspondence information (S540), and returns the process to step S100 in FIG. 9.

In the above, a preferred embodiment of the present disclosure was described. The above-described embodiment has the following features.

That is, the information processing apparatus 2 controls the printing apparatus 3 that executes the print job for the medium positioned by using the positioning paper on which the positioning pattern is printed. The information processing apparatus 2 includes the type information storage portion 30a that stores a plurality of pieces of type information indicating a plurality of types different from each other in the medium. The information processing apparatus 2 includes a pattern information storage portion 30c that stores a plurality of pieces of pattern information indicating a plurality of positioning patterns different from each other. The information processing apparatus 2 includes the correspondence information storage portion 30d that stores correspondence information in which a plurality of pieces of type information and a plurality of pieces of pattern information are associated with each other. The information processing apparatus 2 includes the type information acquisition portion 33 that acquires type information of a medium set for the print job that the printing apparatus 3 intends to execute. The information processing apparatus 2 includes the pattern information extraction portion 34 that extracts pattern information corresponding to the type information acquired by the type information acquisition portion 33 from a plurality of pieces of pattern information stored in the pattern information storage portion 30c by referring to the correspondence information. The information processing apparatus 2 includes the display control portion 35 that displays the pattern information extracted by the pattern information extraction portion 34. According to the above configuration, the positioning pattern suitable for the print job that the printing apparatus 3 intends to execute is displayed, and thus a mismatch between the medium and the positioning pattern can be prevented.

Further, the display control portion 35 displays the pattern information in a character format. According to the above configuration, the user can appropriately understand the positioning pattern suitable for the print job by viewing the pattern identification character string displayed on the print job panel 64.

Further, the display control portion 35 displays the pattern information in an image format. According to the above configuration, the user can appropriately understand the positioning pattern suitable for the print job by viewing the pattern image q displayed in the preview box 63.

Further, the display control portion 35 displays the pattern image q (image) of the positioning pattern indicated by the pattern information and the medium image p (image) to be printed on the medium in a superimposed manner. According to the above configuration, the user can check the consistency between the medium image p and the pattern image q by simultaneously viewing the medium image p and the pattern image q displayed in the preview box 63.

In addition, the pattern information may be image information indicating an outer contour line of the corresponding medium. The pattern information may be dimension parameters of the grid line that assists in positioning the corresponding medium.

The information processing apparatus 2 further includes the registration portion 31 that acquires the type information and the pattern information and registers the correspondence relationship between the type information and the pattern information in correspondence information. According to the above configuration, new media or new positioning patterns can be easily registered in the correspondence information.

Further, the display control portion 35 simultaneously displays the medium image print button 61b for starting printing on the medium and the positioning pattern print button 61c for starting printing of the pattern information displayed by the display control portion 35. According to the above configuration, printing of the positioning pattern can be executed as necessary before the printing on the medium is started.

Further, when the pattern information displayed by the display control portion 35 is not printed within the first period from the time when the medium image print button 61b is operated, the warning portion 36 issues a warning by notification as illustrated in FIG. 15. According to the above configuration, it is estimated that there is no appropriate positioning paper, and thus printing on the medium can be stopped.

Further, when the pattern information displayed by the display control portion 35 is printed within the second period from the time when the positioning pattern print button 61c is operated, the warning portion 36 issues a warning by notification as illustrated in FIG. 16. According to the above configuration, it is estimated that an appropriate positioning paper is already present, and thus the same positioning pattern can be effectively prevented from being printed a plurality of times.

The above embodiment can be modified as follows, for example.

That is, the information processing apparatus 2 may share the print history of each positioning pattern indicated by each pattern information with another information processing apparatus, and may appropriately refer to the shared print history. That is, when one printing apparatus 3 is shared by the plurality of information processing apparatuses 2, there is a concern that the positioning paper may be created in duplicate when each information processing apparatus 2 individually holds the print history of each positioning pattern. Therefore, by sharing the print history among the plurality of information processing apparatuses 2, the positioning paper can be effectively prevented from being created in duplicate.

In the above example, the program can be stored by using various types of non-transitory computer readable media and can be supplied to the computer. The non-transitory computer readable medium includes various types of tangible storage media. Examples of non-transitory computer readable media include magnetic recording media (for example, a flexible disk, a magnetic tape, and a hard disk drive) and magneto-optical recording media (for example, a magneto-optical disk). Examples of non-transitory computer readable media include read only memory (CD-ROM), CD-R, CD-R/W, and semiconductor memory (for example, mask ROM). Examples of non-transitory computer readable media further include programmable ROM (PROM), erasable PROM (EPROM), flash ROM, and random access memory (RAM). The program may be supplied to the computer by various types of transitory computer readable media. Examples of the temporary computer readable medium include an electric signal, an optical signal, and an electromagnetic wave. The temporary computer readable medium can supply a program to a computer via a wired communication path such as a wire and an optical fiber or a wireless communication path.

What is claimed is:

1. An information processing apparatus that controls a printing apparatus executing a print job on a print medium positioned by using a positioning medium on which a positioning pattern is printed, the information processing apparatus comprising:
a type information storage portion that stores a plurality of pieces of type information each indicating a plurality of different types of the print medium;
a pattern information storage portion that stores a plurality of pieces of pattern information each indicating a plurality of the positioning patterns different from each other;
a correspondence information storage portion that stores correspondence information for associating the plurality of pieces of type information and the plurality of pieces of pattern information with each other;
a type information acquisition portion that acquires type information of the print medium set for the print job that the printing apparatus intends to execute;
a pattern information extraction portion that extracts, from the plurality of pieces of pattern information, pattern information corresponding to the type information acquired by the type information acquisition portion by referring to the correspondence information; and
a pattern information display portion that displays the pattern information extracted by the pattern information extraction portion.

2. The information processing apparatus according to claim 1, wherein
the pattern information display portion displays the pattern information in a character format.

3. The information processing apparatus according to claim 1, wherein
the pattern information display portion displays the pattern information in an image format.

4. The information processing apparatus according to claim 3, wherein
the pattern information display portion displays an image of the positioning pattern indicated by the pattern information and an image printed on the print medium in a superimposed manner.

5. The information processing apparatus according to claim 1, wherein
the pattern information is image information indicating an outer contour line of the corresponding print medium.

6. The information processing apparatus according to claim 1, wherein
the pattern information is a dimension parameter of a grid line that assists in positioning of the corresponding print medium.

7. The information processing apparatus according to claim 1, further comprising:
a registration portion that acquires the type information and the pattern information and registers a correspondence relationship between the type information and the pattern information in the correspondence information.

8. The information processing apparatus according to claim 1, further comprising:
a trigger display portion that simultaneously displays a first trigger for starting printing on the print medium and a second trigger for starting printing of the positioning pattern indicated by the pattern information displayed by the pattern information display portion.

9. The information processing apparatus according to claim 1, further comprising:
a trigger display portion that displays a first trigger for starting printing on the print medium; and
a warning portion that issues a warning when the positioning pattern indicated by the pattern information is not printed within a first period from a time when the first trigger is operated.

10. The information processing apparatus according to claim 1, further comprising:
a trigger display portion that displays a second trigger for starting printing of the positioning pattern indicated by the pattern information displayed by the pattern information display portion; and
a warning portion that issues a warning when the positioning pattern indicated by the pattern information is printed within a second period from a time when the second trigger is operated.

11. The information processing apparatus according to claim 9, wherein
the information processing apparatus shares a print history of each positioning pattern indicated by each pattern information with another information processing apparatus.

12. An information processing method for controlling a printing apparatus executing a print job on a print medium positioned by using a positioning medium on which a positioning pattern is printed, wherein
a computer
stores a plurality of pieces of type information each indicating a plurality of different types of the print medium,
stores a plurality of pieces of pattern information each indicating a plurality of the positioning patterns different from each other,
stores correspondence information for associating the plurality of pieces of type information and the plurality of pieces of pattern information with each other,
acquires type information of the print medium set for the print job that the printing apparatus intends to execute,
extracts, from the plurality of pieces of pattern information, pattern information corresponding to the acquired type information by referring to the correspondence information, and
displays the extracted pattern information.

13. A non-transitory computer-readable storage medium storing a program, the program that causes a computer that controls a printing apparatus executing a print job on a print medium positioned by using a positioning medium on which a positioning pattern is printed, to function as
a type information storage portion that stores a plurality of pieces of type information each indicating a plurality of different types of the print medium,
a pattern information storage portion that stores a plurality of pieces of pattern information each indicating a plurality of the positioning patterns different from each other,
a correspondence information storage portion that stores correspondence information for associating the plurality of pieces of type information and the plurality of pieces of pattern information with each other,
a type information acquisition portion that acquires type information of the print medium set for the print job that the printing apparatus intends to execute,
a pattern information extraction portion that extracts, from the plurality of pieces of pattern information, pattern information corresponding to the type information acquired by the type information acquisition portion by referring to the correspondence information, and
a pattern information display portion that displays the pattern information extracted by the pattern information extraction portion.
